(19) United States
(12) Patent Application Publication
(10) Pub. No.: US 2006/0260195 A1
(43) Pub. Date: Nov. 23, 2006

(54) Repositionable gate

(76) Inventors: Thomas J. Witman, Huber Heights, OH (US); Bryan R. Keller, Springboro, OH (US)

Correspondence Address: TAFT, STETTINIUS & HOLLISTER LLP, SUITE 1800, 425 WALNUT STREET, CINCINNATI, OH, 45202-3957, US

(21) Appl. No.: 11/120,134

(22) Filed: May 2, 2005

(51) Int. Cl. E06B 9/01

(52) U.S. Cl. 49/57; 49/463

(57) ABSTRACT

A pressure gate comprising: (a) a frame assembly adapted to be wedged between corresponding boundaries of an opening, the frame assembly including repositionable frame members to change a widthwise dimension of the frame assembly; (b) a repositionable door mounted to the frame assembly; and (c) a repositionable stop mounted to the frame assembly, the repositionable stop comprising a clutch mounted to a bumper, the clutch engaged by a wheel so that rotational movement of the wheel is operative to reposition the bumper coaxially with respect to the wheel, where a predetermined resistance against the bumper is operative to cause the clutch to slip when engaged by the wheel to inhibit further coaxial movement of the bumper.

### RELATED ART

1. Field of the Invention

The present invention is directed to repositionable barriers that are adapted to span across openings of various widths and, more specifically, repositionable barriers with repositionable doors to provide selective egress through an opening.

2. Brief Discussion of Related Art

Various types of adjustable-width pressure-fit gates are known in the art. These gates are adapted to be wedged between the boundaries of an opening to inhibit egress through the opening. Pressure gates have been utilized for applications such as maintaining a child within a particular area or maintaining a pet within a particular area. In each instance, the gates are removable when the functionality of the gate is not longer needed.

### SUMMARY

The present invention is directed to barriers across an opening and, more specifically, repositionable barriers to inhibit travel through an opening.

The invention includes a pressure gate comprising: (a) a frame assembly adapted to be wedged between corresponding boundaries of an opening, the frame assembly including repositionable frame members to change a widthwise dimension of the frame assembly; (b) a repositionable door mounted to the frame assembly; and (c) a repositionable stop mounted to the frame assembly, the repositionable stop comprising a clutch mounted to a bumper, the clutch engaged by a wheel so that rotational movement of the wheel is operative to reposition the bumper coaxially with respect to the wheel, where a predetermined resistance against the bumper is operative to cause the clutch to slip when engaged by the wheel to inhibit further coaxial movement of the bumper.

The present invention also includes various aspects of a repositionable gate such as, without limitation, reconfigurable gates that are widthwise adjustable, reconfigurable gates that include a swinging door that is widthwise adjustable, reconfigurable gates that include a swinging door with a repositionable latch mechanism, reconfigurable gates that include a swinging door with hanging hinges that face opposite one another, reconfigurable gates that include a swinging door that locks to the surrounding frame assembly, reconfigurable gates that include an extendable bumper with integrated clutch assembly, and reconfigurable gates that are extendable by adding fixed dimension extensions.

The aforementioned aspects of the present invention should not be considered completely inclusive of the present invention. Reference is had to the Detailed Description for a more accurate and inclusive understanding of the invention.

### BRIEF DESCRIPTION OF THE DRAWINGS

FIG. 1 is an elevated perspective view of a first exemplary embodiment of the present invention;

FIG. 2 is a bottom perspective view of the first exemplary embodiment of FIG. 1, shown in a contracted position;

FIG. 3 is a bottom perspective view of the first exemplary embodiment of FIG. 1, shown in an extended position;

FIG. 4 is a bottom view of the first exemplary embodiment of FIG. 1;

FIG. 5 is an elevated perspective view of a first exemplary embodiment of the present invention, with the door open;

FIG. 6 is an elevated perspective view of a first exemplary embodiment of the present invention, with the door omitted;

FIG. 7 is a close-up perspective view of an exemplary lower hinge bracket mounted to a vertical support for use with the present invention;

FIG. 8 is a close-up perspective view of an exemplary upper hinge bracket mounted to a vertical support for use with the present invention;

FIG. 9 is a perspective view of an exemplary adjustable bumper for use with the present invention;

FIG. 10 is a partially exploded and cut-away frontal view of the exemplary adjustable bumper of FIG. 9;

FIG. 11 is a partially exploded and cut-away rear view of the exemplary adjustable bumper of FIG. 9;

FIG. 12 is a cross-sectional view of the exemplary adjustable bumper of FIG. 9;

FIG. 13 is a cross-sectional, exploded view of the exemplary adjustable bumper of FIG. 9;

FIG. 14 is a close-up, elevated perspective view of an exemplary adjustable track for a door in accordance with the present invention;

FIG. 15 is an elevated perspective and cut-away view of the exemplary adjustable member to adjust the width of a door in accordance with the present invention;

FIG. 16 is a cut-away view of an exemplary handle structure for use with the present invention;

FIG. 17 is a cut-away view of an exemplary handle structure of FIG. 16, with the trigger in the operative position; and

FIG. 18 is a cut-away view of an exemplary handle structure of FIG. 16, with the latch retracted.

### DETAILED DESCRIPTION

The exemplary embodiments of the present invention are described and illustrated below to encompass barriers for openings and associated techniques for installing, operating, and removing the barriers from such openings. Of course, it will be apparent to those of ordinary skill in the art that the preferred embodiments discussed below are exemplary in nature and may be reconfigured without departing from the scope and spirit of the present invention. However, for clarity and precision, the exemplary embodiments as discussed below may include optional steps, methods, and features that one of ordinary skill should recognize as not being a requisite to fall within the scope of the present invention.

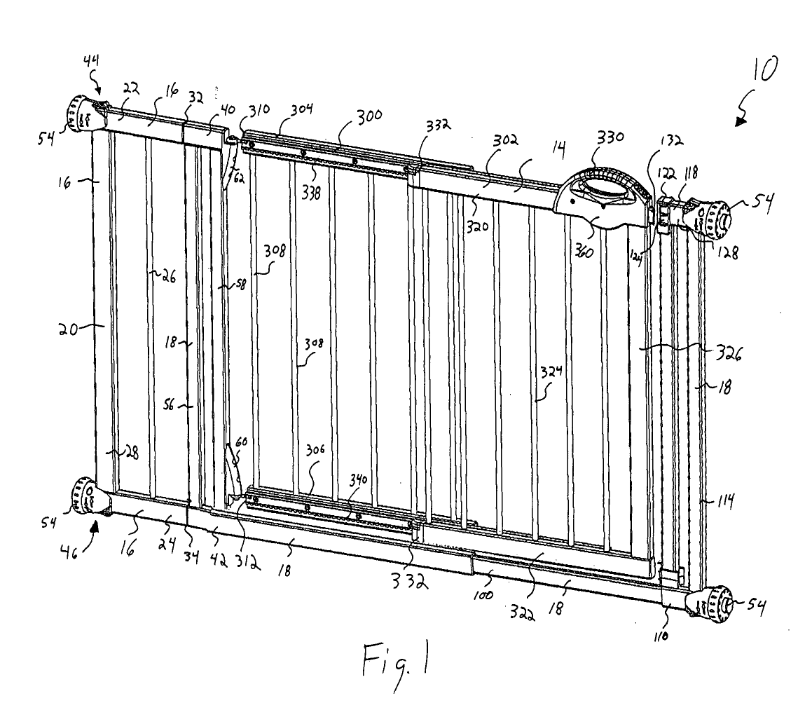

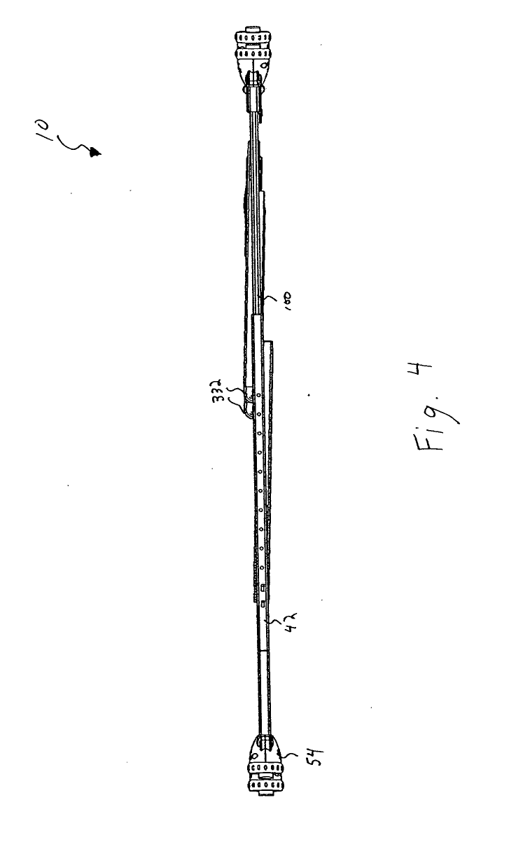

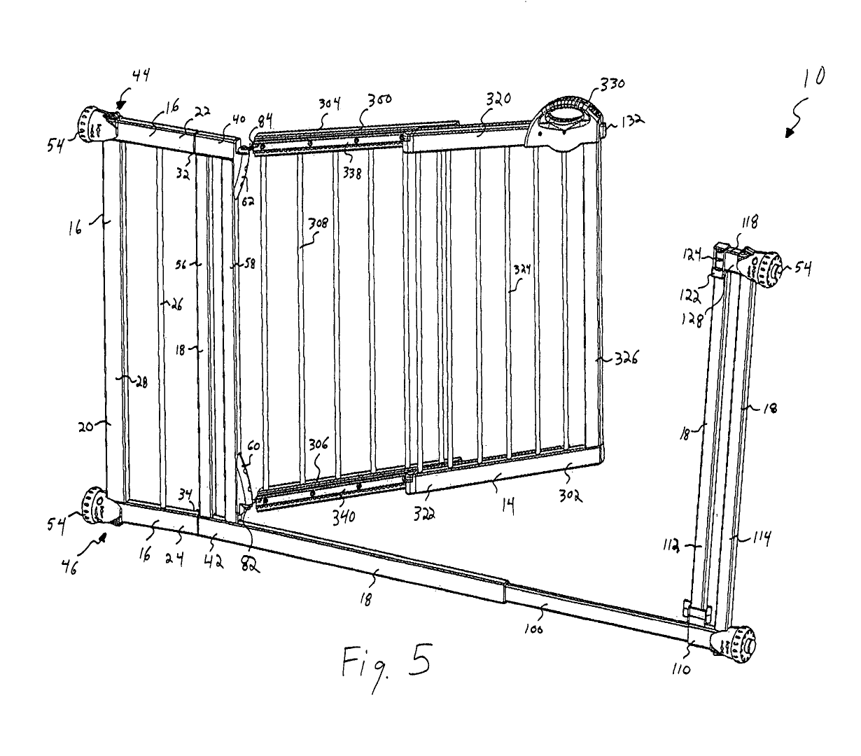

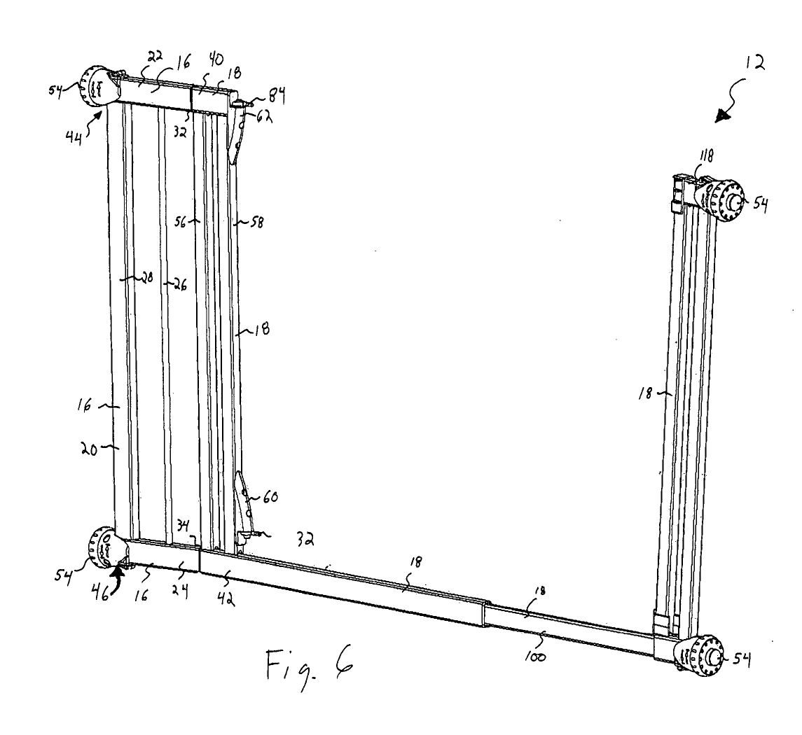

Referencing FIGS. 1-6, a first exemplary pressure gate 10 includes a frame assembly 12 that supports a swinging door 14, where the frame assembly 12 is adapted to be wedged within an opening (not shown) to selectively inhibit egress through the opening. A frame extension member 16, which is frictionally mounted to one end of a primary frame assembly 18, includes a vertical support 20 mounted to opposing horizontal supports 22, 24 that are separated by a reinforcing member 26. The vertical support 20 and horizontal supports 22, 24 are fabricated from hollow rectangular bar stock and are welded together to vertically align the ends of the horizontal supports 22, 24 with the vertical face 28 of the vertical support 20. Hollow rectangular bar stock adapters (not shown) are welded to corresponding ends 32, 34 of the horizontal supports 22, 24 to provide a rectangular cross-section adapted to fit within openings (not shown) at the ends of the horizontal supports 40, 42 of the primary frame assembly 18. Opposing ends 44, 46 of the horizontal supports 22, 24 include plastic inserts (not shown) to facilitate a friction fit between end openings of the horizontal supports 22, 24 and respective adjustment bumpers 54.

In an alternate exemplary embodiment, the frame assembly 12 is amendable to be indefinitely extended by sequentially adding frame extension members 16 to one another. In such an exemplary embodiment, the end openings of corresponding horizontal supports 22, 24 of a first frame extension member 16 are adapted to receive corresponding hollow rectangular bar stock adapters of a second frame extension member. This assembly procedure may be repeated indefinitely to accommodate openings of various widths, with the outermost frame extension member 16 receiving adjustment bumpers 54 within the pair of end openings.

The primary frame assembly 18 includes a first horizontal support 40 vertically separated from a second horizontal support 42 by a pair of vertical supports 56, 58. The vertical supports 56, 58 are fabricated from hollow rectangular bar stock and are welded to the horizontal supports 40, 42, which are likewise fabricated from hollow rectangular bar stock. A lower hinge bracket 60 and an upper hinge bracket 62 are anchored to the innermost vertical support 58.

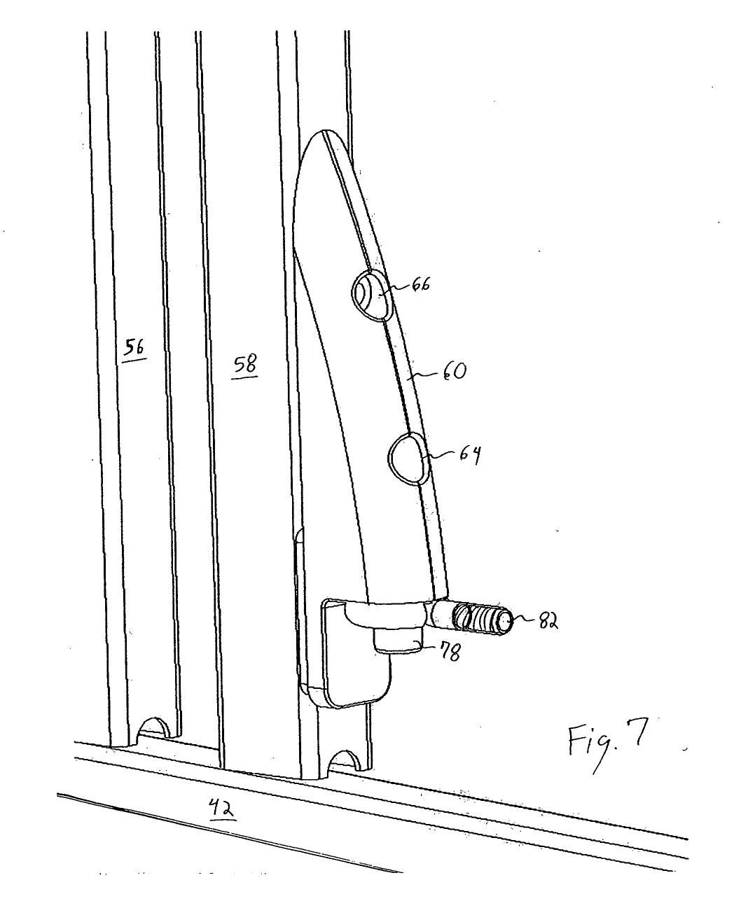

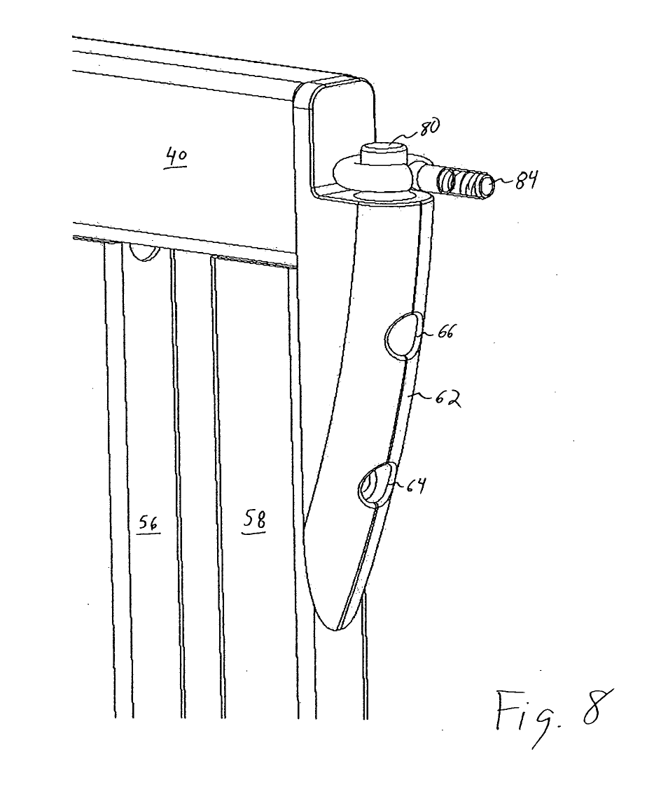

Referring to FIGS. 7 and 8, the lower hinge bracket 60 and the upper hinge bracket 62 each include two holes 64, 66 therethrough, as well as male adapters (not shown) adapted to be wedged within corresponding openings (not shown) in the innermost vertical support 58 and an end of the first horizontal supports 40. The holes 64, 66 through the brackets 60, 62 receive screws to further attach the brackets to the first horizontal support 40 and innermost vertical support 58. Both the upper hinge bracket 62 and the lower hinge bracket 60 include a cylindrical projection 78, 80 that is respectively circumscribed by an eye of an eyebolt 82, 84. The cylindrical projections 78, 80 face away from one another so that the north facing projection 80 pierces the eye of the top eyebolt 84, whereas the south facing projection 78 pierces the eye of the bottom eyebolt 82. The eyebolts 82, 84 are mounted to respective top and bottom bars 304, 306 of the swinging door 14 (see FIG. 1) in order to mount the door to the primary frame assembly 18. Unlike prior art hinges, the present hinge structure utilizes the upper hinge bracket 62 to bear the majority of the weight of the swinging door 14, whereas the lower hinge bracket 60 is utilized moreso as a guide. As will be explained in more detail below, the eyebolts 82, 84 provide widthwise adjustability for the swinging door 14 to precisely accommodate the internal width of the primary frame assembly 18.

Referencing FIGS. 1-6, the hollow rectangular bar stock comprising the second horizontal support 42 extends outward beyond the innermost vertical support 58 and receives a coaxial horizontal support 100. The coaxial horizontal support 100 has a longitudinal cross-section that fits within the rectangular longitudinal cross-section of the second horizontal support 42 to allow a sliding action between the supports 42, 100. A bottom surface 102 of the horizontal support 42 includes a series of spaced apart holes 104, where at least one of the holes receives a spring-biased dowel 106 mounted to the coaxial horizontal support 100. The spring-biased dowel 106 when inserted within one of the holes 104 maintains the relative position of the second horizontal support 42 with respect to the coaxial horizontal support 100, thereby maintaining the overall width of the primary frame assembly 18. To manipulate the width of the primary frame assembly 18, the dowel 106 is pushed inward beyond the line of travel of the support 100, thereby allowing a sliding action to occur between the supports 42, 100. When the sliding action is relatively slow, the bias will force the dowel 106 outward and into the next corresponding hole 104 coming into alignment therewith to incrementally adjust the width of the primary frame assembly 18. In contrast, when the sliding action is relatively quick, the dowel 106 may pass beyond several holes 104 before the spring bias forces the dowel into one of the holes. The process of pushing the dowel 106 inward and beyond the line of travel of the coaxial horizontal support 100 may be repeated numerous times until the appropriate width of the primary frame assembly 18 is established.

The coaxial horizontal support 100 is welded to a hollow rectangular bar stock horizontal member 110. Two vertical members 112, 114 are welded to the horizontal member 110 at one end, and are concurrently welded to a second horizontal member 118 and a second, opposing end. Hollow rectangular bar stock is utilized for the two vertical members 112, 114 and the second horizontal member 118. An open end of the second horizontal member 118 includes a latch catch insert 122 having two semicircular projections 124 that extend perpendicularly from opposing faces 128 of the second horizontal member 118. The semicircular projections 124 are adapted to contact a spring biased, reciprocating latch 132 of the swinging door 14 so that when the latch contacts either projection, the latch slides against the arcuate contour of the projection and overcomes the bias to push the latch inward. The latch catch insert 122 also includes an opening (not shown) that is adapted to receive the reciprocating latch 132 of the swinging door 14 after the latch passes beyond one of the projections to generally maintain the orientation of the swinging door 14 with respect to the primary frame assembly 18.

Corresponding ends of each horizontal member 110, 118 are open and may include a plastic insert (not shown) to decrease the cross sectional areas of the openings. In this exemplary embodiment, a corresponding adjustment bumper 54 occupies each opening, however, it is also within the scope of the invention that a pair of hollow rectangular bar stock adapters of a frame extension member 16 occupy these openings. In this manner, frame extension members may be utilized to increase the widthwise dimension of the frame assembly 12.

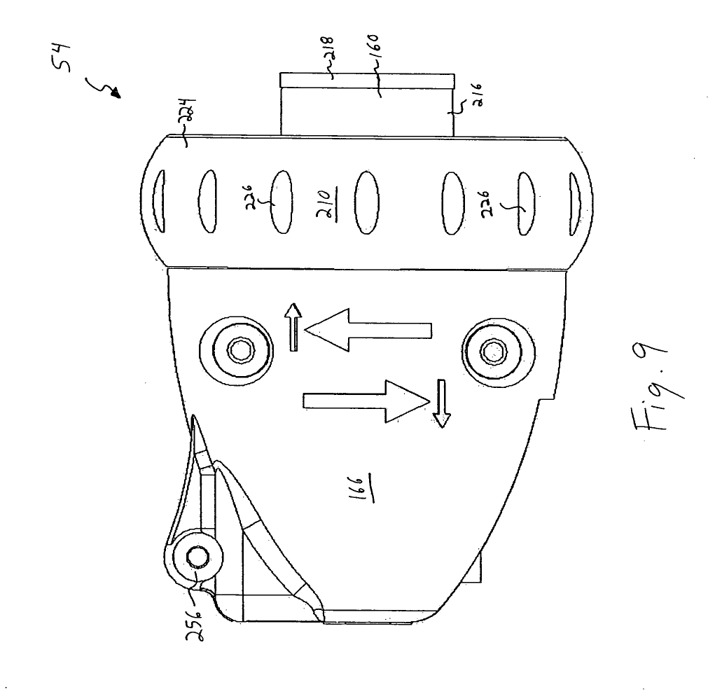

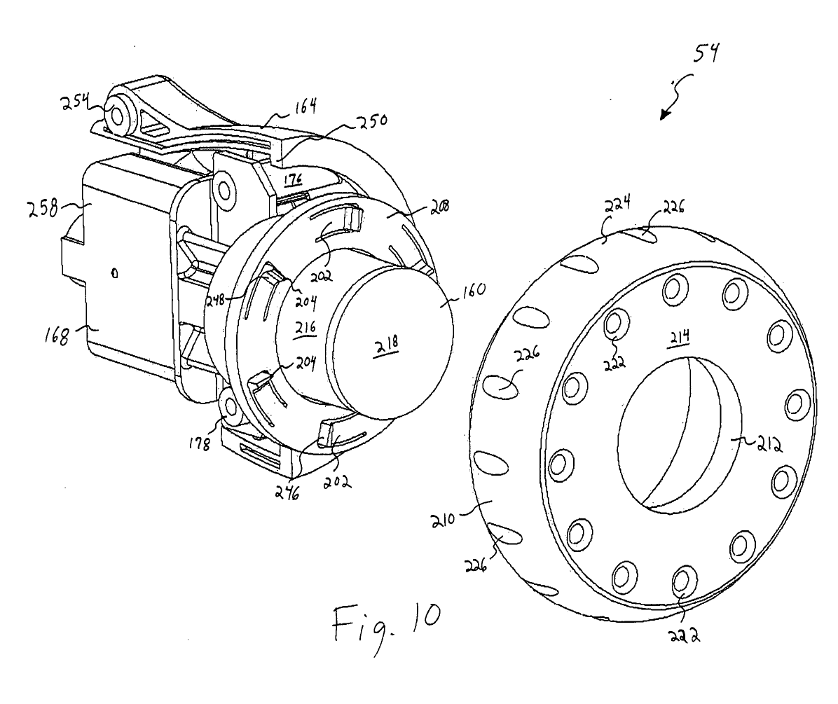

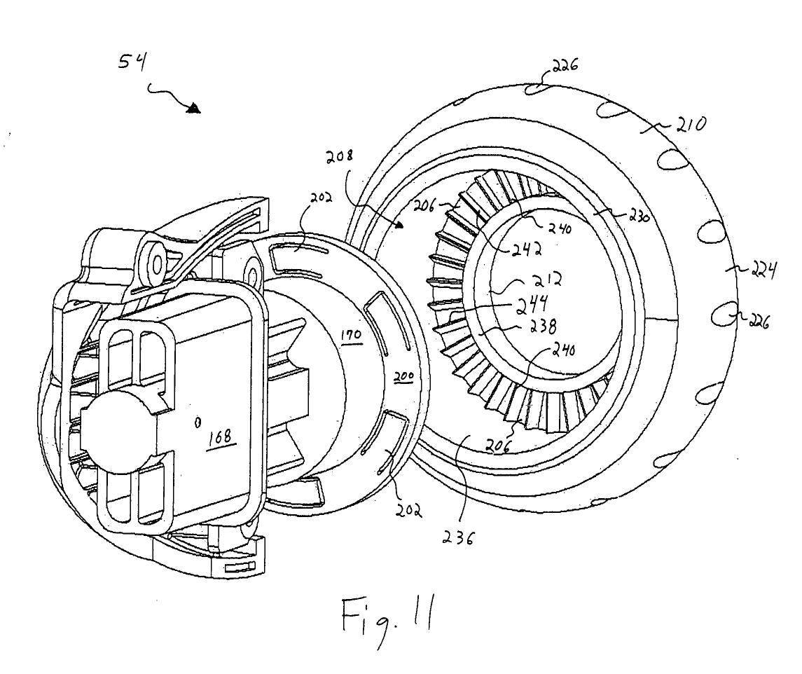

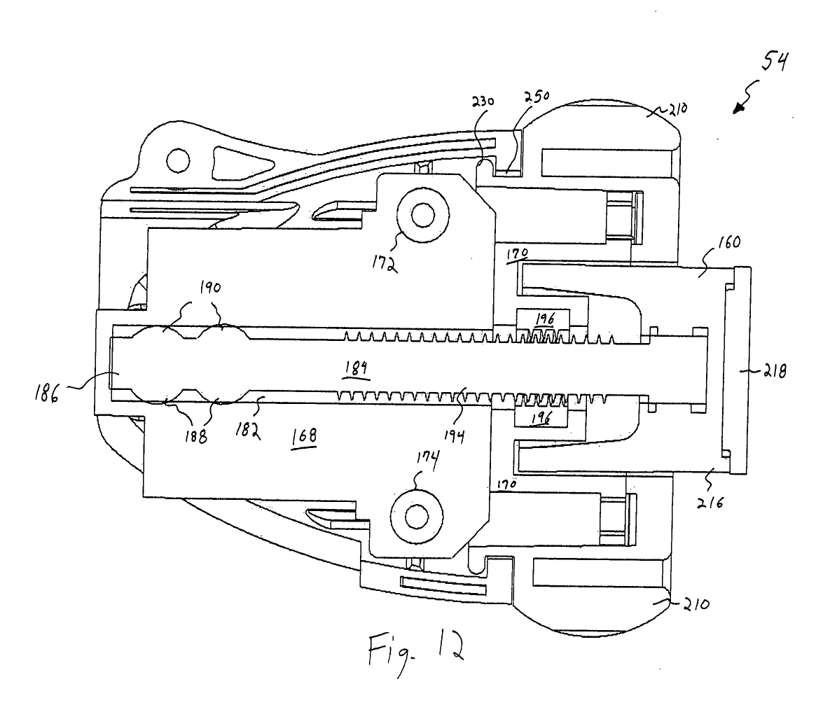

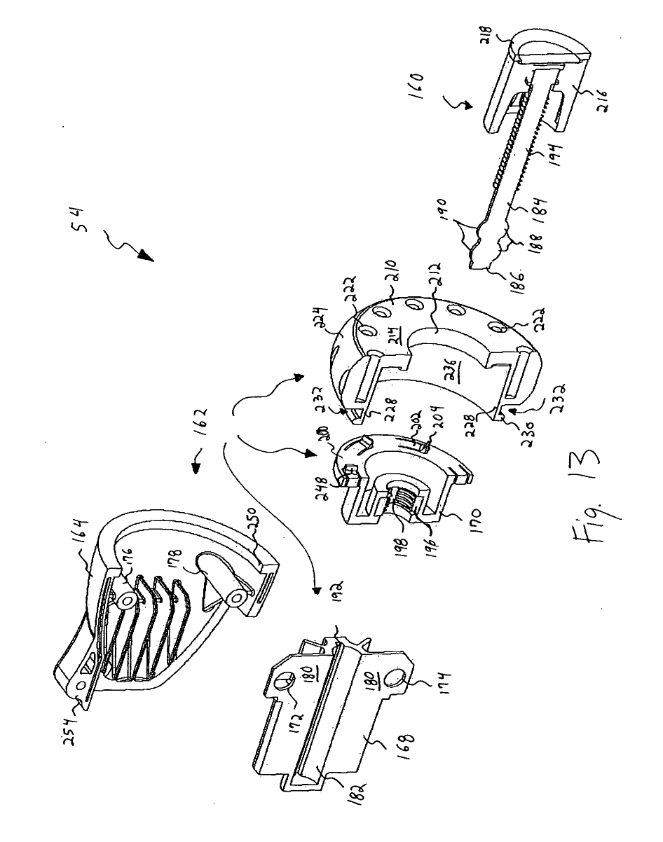

Referring to FIGS. 9-13, the exemplary adjustment bumpers 54 are operative to reposition an abutment plug 160 inward and outward from a main housing 162 in order to appropriately wedge the pressure gate 10 within an opening. Each adjustment bumper includes a pair of injection molded convex outer housings 164, 166 that house a plug guide 168 and a clutch 170. The plug guide 168 includes two openings 172, 174 that are adapted to be pierced by a first set of corresponding columns 176, 178 mounted to the first outer housing 164. Two columns (not shown) of the second outer housing 166 abut the first set of columns 176, 178 and a plate 180 of the plug guide 168 that surrounds the openings 172, 174 to effectively sandwich the plug guide between the columns upon assembly. The plug guide 168 includes a longitudinal channel 182 adapted to receive a bolt 184 of the abutment plug 160. A distal end 186 of the bolt 184 is crimped to provide two pair of linear guides 188, 190, where each pair of linear guides are 180 degrees from one another. The linear guides 188, 190 are received within corresponding grooves 192 of the longitudinal channel 182 and inhibit the bolt 184 from rotating.

A proximal section 194 of the bolt 184 is threaded and adapted to interface with a threaded nut 196 mounted to the clutch 170. The threaded nut 196 also includes two linear grooves 198 adapted to allow throughput of the linear guides 188, 190 of the bolt 184. The clutch 170 is injection molded over the threaded nut 196 to inhibit rotation of the nut independent of the clutch. A circumferential disc 200 of the clutch 170 includes a series of U-shaped cutouts defining a plurality of biased prongs 202 with leading edges 204 interfacing with pockets 206 circumferentially distributed about a backside 208 of a wheel 210.

The wheel 210 includes a circular opening 212 through the front face 214 enabling throughput of a majority of the abutment plug 160. A cylindrical covering 216 is mounted to the proximal tip of the bolt 184. The front of the covering 216 includes an injection molded elastomeric layer 218 adapted to abut a boundary of an opening, such as a doorframe. This elastomeric layer 218 circumferentially extends beyond a cylindrical covering 216 of the plug 160. In other words, the diameter of the cylindrical covering 216 is fabricated from a more rigid polymer is less than the diameter of the elastomeric layer 218 at the front of the plug 160. The frontal opening 212 includes a diameter that accommodates the diameter of the cylindrical covering 216, but is not large enough to accommodate throughput of the elastomeric layer 218. Thus, all of the abutment plug 160 but for the elastomeric layer 218 can pass through the frontal opening 212 of the wheel 210.

The front face 214 of the wheel 210 includes a series of cylindrical cavities 222 distributed in a circular manner approximate a top arcuate surface 224 of the wheel. A series of depressions 226 are distributed about the arcuate surface 224 to facilitate gripping by a user to reposition the abutment plug 160 as will be discussed in more detail below. A circular ring 228 protrudes from the rear of the wheel 210 and includes a circular flange 230 extending in a perpendicular manner. The orientation of the rear surface of the wheel 210, ring 228, and flange 230 cooperate to define a circumferential channel 232. The backside 208 of the wheel 210 includes an inner cylindrical wall 236 that extends to abut the pockets 206. The pockets 206 are bounded by the cylindrical wall 236, an inner circular wall 238, and a series of pyramidal fins 240. The fins 240 include a generally perpendicular face 242 and an acute angled face 244. The perpendicular face 242 of the fins is oriented to contact a perpendicular face 246 of each leading edge 204, whereas the acute angled face 244 of the fins 240 is oriented to contact an acute angled face 248 of each leading edge 204. In this manner, counterclockwise rotation of the wheel 210 is operative to direct the perpendicular faces 246 of the leading edges 204 against a corresponding perpendicular face 242 of the fins 240 to rotate the clutch 170 in a counterclockwise direction. In contrast, clockwise rotation of the wheel 210 is operative to direct the acute angled faces 248 of the leading edges 204 against a corresponding acute angled face 244 of the fins 240 to rotate the clutch 170 in a clockwise direction.

To assembly an exemplary adjustment bumper 54, the clutch 170 is positioned within the inner cylindrical wall 236 so that the leading edges 204 are operative to interface with the pockets 206 of the wheel 210. The plug guide 168 is oriented so that the two openings 172, 174 are pierced by the columns 176, 178 of the first outer housing 164. The wheel 210, with the clutch 170 therein, is positioned to abut the front of the plug guide so that a semicircular plateau 250 of the first outer housing 164 is seated within the circumferential channel 232. Thereafter, the second outer housing 166 is aligned with the first outer housing 164 so that the two columns (not shown) abut the first set of columns 176, 178 and the plate 180 of the plug guide 168 that surrounds the openings 172, 174 to effectively sandwich the plug guide between the columns. The alignment of the housings 164, 166 is also operative to seat the semicircular plateau 250 of the second outer housing 166 within the circumferential channel 232. Two screws (not shown) are installed to couple the columns to mount the housings 164, 166 to one another. In addition, a third screw is inserted through corresponding aspects 254, 256 of a mounting bracket to mount the housings 164, 166 to one another. After the housings 164, 166 are mounted to one another, the rear of the adjustment bumper 54 is open to allow the rectangular aspect 258 of the plug guide 168 to be mounted within a rectangular opening in one of horizontal supports 22, 24 or the first or second horizontal member 110, 118. The abutment plug 160 is inserted after the housings 164, 166 have been mounted to one another. The wheel 210 is rotated to rotate the clutch 170 to align the two linear grooves 198 with the grooves 192 of the longitudinal channel 182, thereby enabling insertion of the linear guides 188, 190 of the bolt 184. After the bolt 184 has been inserted to a depth where the threads of the bolt interface with the threads of the nut 196, the wheel is rotated in a counterclockwise direction to draw the bolt inward and bring the elastomeric layer 218 toward the front face 214. Continued counterclockwise rotation will eventually draw the bolt inward to a point where the elastomeric layer 218 almost abuts the front face 214.

In operation, adjustment bumper 54 is mounted to a rectangular opening in one of horizontal supports 22, 24 or the first or second horizontal member 110, 118. To secure the frame assembly 12 within an opening, the bolt 184 is repositioned inward toward the wheel 210 to decrease the width of the frame assembly or the bolt is repositioned outward away from the wheel 210 to increase the width of the frame assembly. Clockwise rotation of the wheel 210 is operative to engage the acute angled faces of the leading

Referring to FIGS. 1-5, the swinging door 14 includes two sections 300, 302 that are slidably mounted to one another to increase or decrease the width of the door. The first section 300 includes a top bar 304 mounted to a bottom bar 306 via a plurality of vertical dividers 308. The top bar 304 and bottom bar 306 are fabricated from hollow rectangular bar stock and are welded to the plurality of circular solid bars comprising the vertical dividers 308. Corresponding ends 310, 312 of the top bar 304 and the bottom bar 306 are each enclosed with a welded metal plate that includes a hole tapped to provided a threaded interface (not shown). Each threaded interface receives one of the threaded ends of the eyebolts 82, 84 to mount the swinging door 14 to the frame assembly 12. As discussed previously, the eyebolts 82, 84 can be screwed inward toward or screwed outward from the each threaded interface to adjust the width of the swinging door 14.

The second section 302 also includes a top bar 320 mounted to a bottom bar 322 via a plurality of vertical dividers 324. A vertical bar 326 is also welded to the ends of the top bar 320 and bottom bar 322, where the vertical bar 326 sits squarely on top of the bottom bar 322. The welded junction between the vertical bar 326 and the top bar 320 only occurs between two corners such that the vertical bar 326 is outset from the top bar 320 to leave a rectangular opening (not shown) within the top of the vertical bar. This vertical opening receives a rectangular insert from a handle assembly 330 that, along with two screws, mounts the handle assembly to the second section 302. Corresponding ends of the top bar 320 and the bottom bar 322 each include inserts having widthwise adjusters 332. Two slides each having a C-shaped channel are respectively mounted to the backside of the top bar 320 and the bottom bar 322. The C-shaped channels of each slide are adapted to receive an I-shaped track 338, 340 respectively mounted to the top bar 304 and bottom bar 306 of the first section 300.

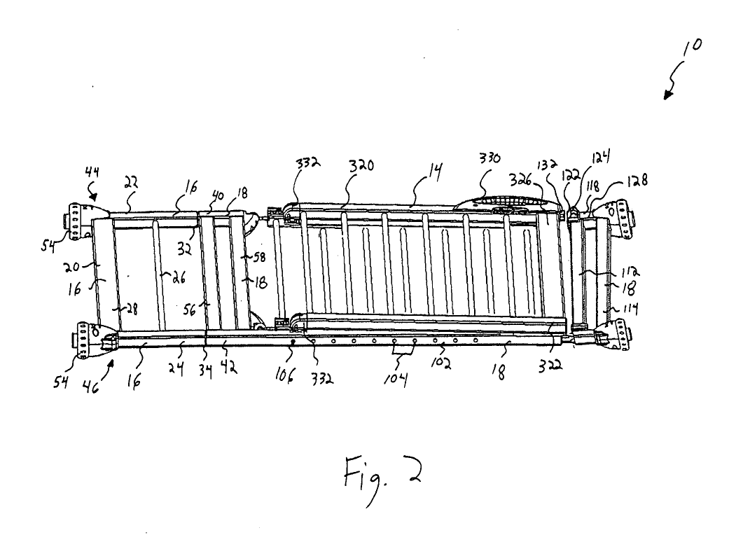

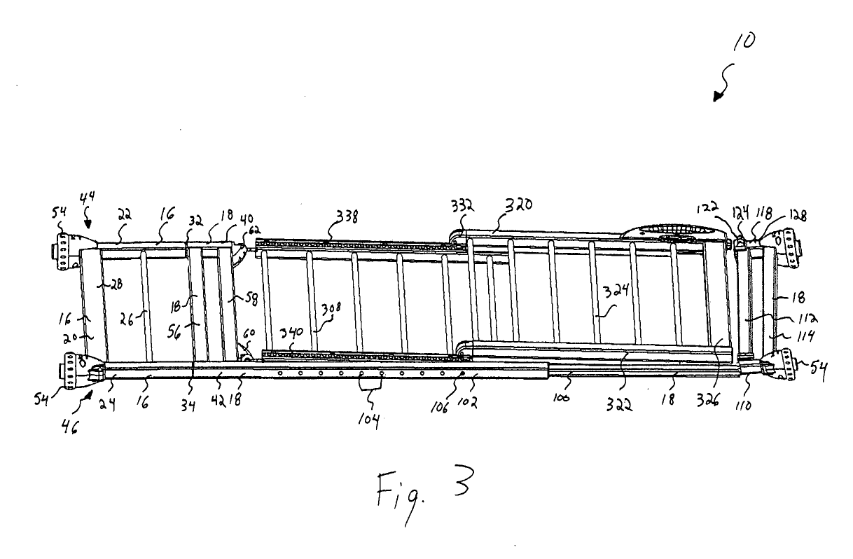

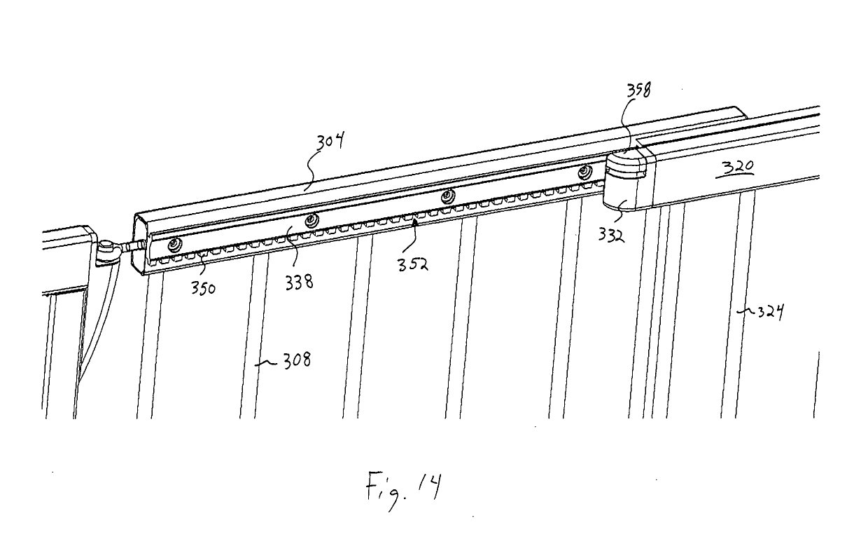

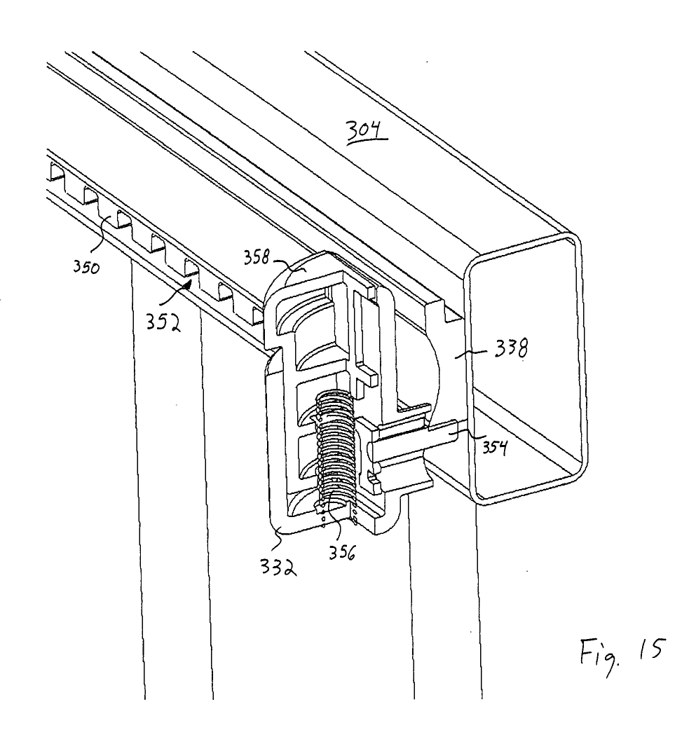

Referencing FIGS. 1-3, 14, and 15, the widthwise adjusters 332 are operative to fix the relative orientation of the sections 300, 302 with respect to one another, but may be actuated to change the overall width of the swinging door 14. Each I-shaped track includes a series of evenly spaced teeth 350 providing gaps 352 therebetween. Each widthwise adjuster 332 includes a set pin 354 that is biased by a spring 356 into one of the gaps 352 to inhibit sliding of the sections 300, 302 with respect to one another. When one desires to increase or decrease the width of the swinging door 14 by sliding the sections 300, 302 with respect to one another, one actuator 358 of each adjuster 332 is depressed to overcome the bias exerted upon the set pin 354 and reposition the pin from the gap it previously occupied. While both actuators 358 are depressed, and while the each pin is not within a gap 352, the sections may be repositioned with respect to one another by sliding the second section 302 along the I-channel until the desired width has been reached. Thereafter, the actuators 358 are no longer depressed to allow the bias of the springs 356 to force each pin 354 upward and into one of the gaps 352 between the teeth 350. This process may be repeated at any time to amend the widthwise dimension of the swinging door 14. For example, FIG. 2 shows a relatively narrow swinging door 14, in comparison to the relatively wide swinging door 14 of FIG. 3.

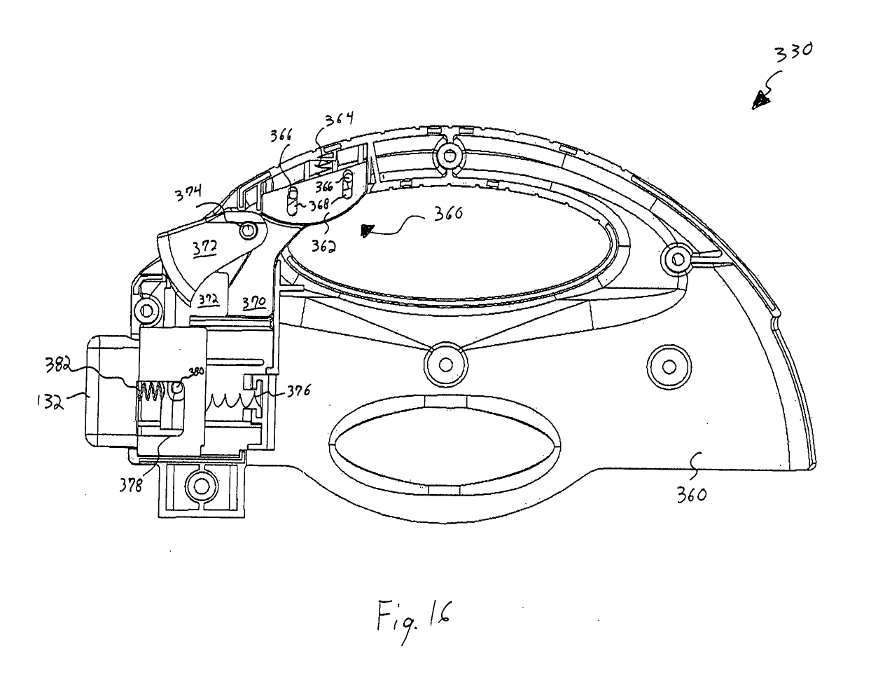

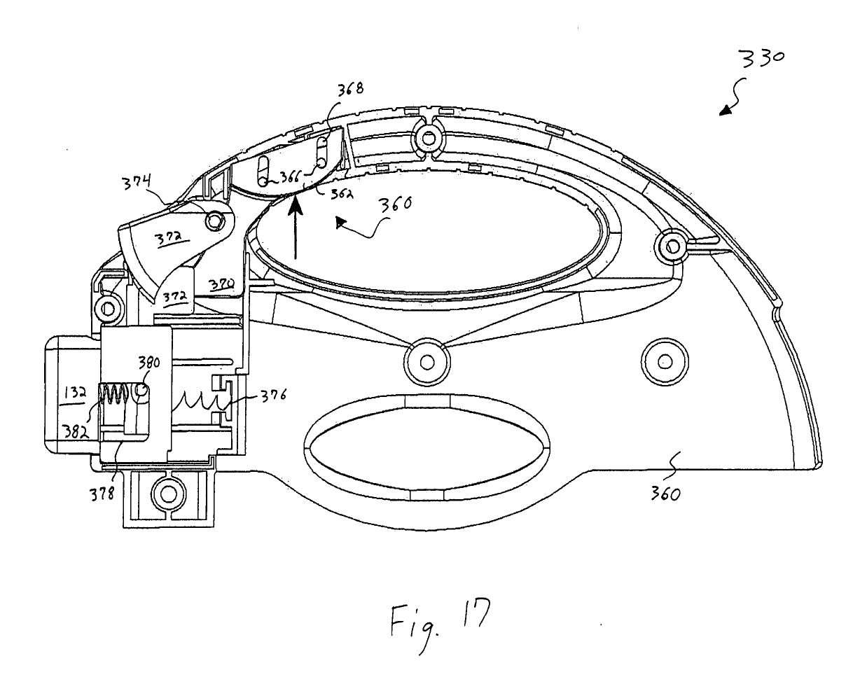

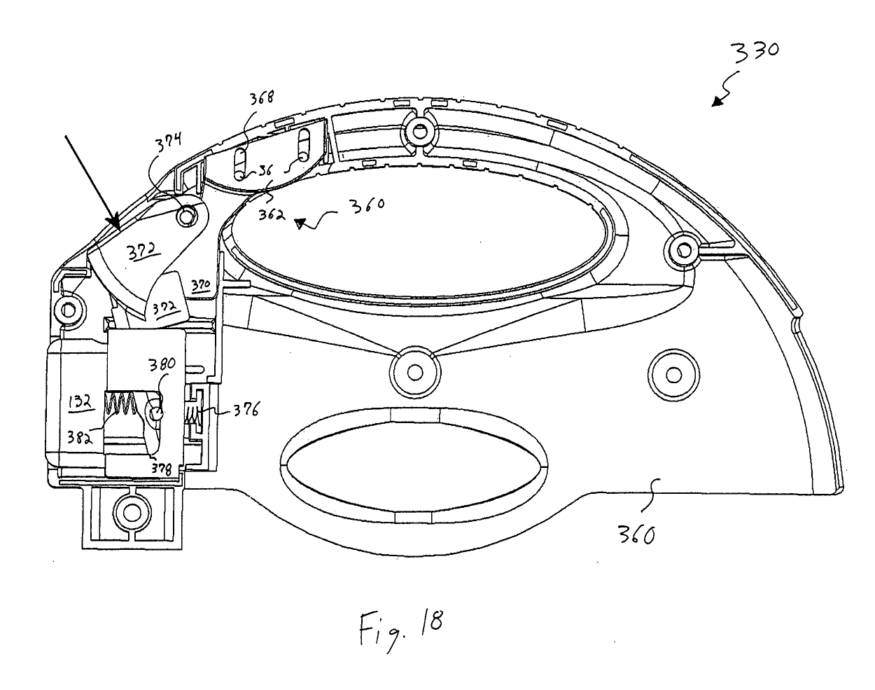

Referring to FIGS. 16-18, the handle assembly 330 includes two injection molded housings 360 that are operative to contain the internal mechanisms that providing for repositioning of the reciprocating latch 132. As discussed previously, the reciprocating latch 132 interfaces with the latch catch insert 122 (see FIG. 1) to mount the swinging door 14 to the second horizontal member 118 of the primary frame assembly 18. The internal mechanisms includes a safety 360 that comprises a trigger 362, a spring 364 to bias the trigger in the safe position as shown in FIG. 16, and a set of alignment pins 366 that ride within corresponding oblong holes 368 that extend through the trigger 362. The trigger 362 is vertically repositionable by a user lifting up with, for example, an index finger to overcome the bias of the spring 364 and move the trigger 362 to the operative position shown in FIG. 17. In the operative position, a lower aspect 370 of the trigger 362 no longer blocks the line of travel of a moment arm 372 that pivots about point 374. The arrow of FIG. 18 shows depression of the moment arm 372, for example by a thumb of a user. This depressive force is operative to overcome a bias of a spring 376 and pivot the moment arm 372 about point 374. A cut-out 378 is provided through the side of the reciprocating latch 132 that a contact rod 380 of the moment arm 372 protrudes through. In this manner, pivoting action of the moment arm 372 resulting from depression as represented by the arrow of FIG. 18 is operative to push the contact rod 380 against the border of the cut-out 378, thereby for moving the reciprocating latch 132 rearward (compare FIGS. 17 and 18). Rearward movement of the reciprocating latch 132 to the position shown in FIG. 18 is operative to no longer continue the engagement between the primary frame assembly 18 and the swinging door 14, thereby allowing the door to swing freely.

Referring to FIGS. 1, 16 and 17, the reciprocating latch 132 can also be moved rearward as a result of contact with one of the two semicircular projections 124 that extend perpendicularly from opposing faces of the second horizontal member 118. When the latch 132 contacts one of the projections 124 while the swinging door 14 is coming into alignment with the primary frame assembly 18, the latch 132 is operative to independently slide rearward with respect to the moment arm 372. Interaction between the latch 132 and one of the projections 124 is operative to overcome a bias of a spring 382 interposing the latch and the moment arm to force the latch 132 rearward. If the trigger 362 is engaged in the operative position as shown in FIG. 17, the interaction between the latch 132 and one of the projections 124 is operative to overcome the bias of at least one of the springs 376, 382 to allow a combination of rearward movement of the latch and pivoting of the moment arm 372. When no, or an insufficient force is action upon the latch 132, the biased nature of the trigger 362, the moment arm 372, and the latch itself are operative to return the components in a stand-by position as shown in FIG. 16.

It is to be understood that the pressure gate 10 described above is exemplary in nature and modifications to the gate may be made without departing from the scope of the present invention. For example, the hollow rectangular bar stock may be replaced with polymer hollow rectangular bar stock or other components of various materials that provide at least similar functionality. Moreover, this example extends to any of the components and pieces discussed above, as materials, design elements, and shapes may be reconfigured or replaced by other materials, design elements, and shapes providing at least similar functionality. It is further within the scope of the invention that the mounting techniques recited herein are exemplary in nature and may be replaced or supplemented by other mounting techniques. For instance, the exemplary welds between the metallic components may be replaced by other fastening devices and techniques for mounting metallic components together, where as different materials may also lend to different mounting techniques. For example, if the vertical supports and horizontal supports were fabricated from polymer materials, a snap fit between the polymer supports may be preferable over polymer welding.

It is also within the scope of the invention to exchange complementary components. For example, the horizontal support 42 may include a spring-biased dowel, and the coaxial horizontal support 100 may include a series of spaced apart holes. Likewise, the handle assembly may be mounted to the primary frame assembly and the latch may engage a latch catch insert mounted to the swinging door 14. These are simply exemplary instances where the mounting structure of the complementary components can be switched or reconfigured, each of which shall fall within the scope of the present invention.

Following from the above description and invention summaries, it should be apparent to those of ordinary skill in the art that, while the methods and apparatuses herein described constitute exemplary embodiments of the present invention, the invention contained herein is not limited to this precise embodiment and that changes may be made to such embodiments without departing from the scope of the invention as defined by the claims. Additionally, it is to be understood that the invention is defined by the claims and it is not intended that any limitations or elements describing the exemplary embodiments set forth herein are to be incorporated into the interpretation of any claim element unless such limitation or element is explicitly stated. Likewise, it is to be understood that it is not necessary to meet any or all of the identified advantages or objects of the invention disclosed herein in order to fall within the scope of any claims, since the invention is defined by the claims and since inherent and/or unforeseen advantages of the present invention may exist even though they may not have been explicitly discussed herein.

What is claimed is:

1. A repositionable stop for a pressure gate comprising:
a clutch mounted to a bumper, the clutch engaged by a wheel so that rotational movement of the wheel is operative to reposition the bumper coaxially with respect to the wheel, where a predetermined resistance against the bumper is operative to cause the clutch to slip when engaged by the wheel to inhibit further coaxial movement of the bumper.

2. The repositionable stop of claim 1, wherein:
the wheel includes an orifice that the bumper is adapted to move therethrough;
the bumper includes a threaded aspect; and
the threaded aspect of the bumper interfaces with a threaded aspect of the clutch.

3. The repositionable stop of claim 2, wherein:
the clutch includes a circular plate with a plurality of projections axially distributed thereabout;
the wheel includes a plurality of projections adapted to engage the plurality of projections of the clutch to reposition the bumper;

4. A pressure gate comprising:
a frame assembly adapted to be wedged between corresponding boundaries of an opening, the frame assembly including repositionable frame members to change a widthwise dimension of the frame assembly;
a repositionable door mounted to the frame assembly; and
a repositionable stop mounted to the frame assembly, the repositionable stop comprising a clutch mounted to a bumper, the clutch engaged by a wheel so that rotational movement of the wheel is operative to reposition the bumper coaxially with respect to the wheel, where a predetermined resistance against the bumper is operative to cause the clutch to slip when engaged by the wheel to inhibit further coaxial movement of the bumper.

5. The pressure gate of claim 4, wherein the repositionable frame members include a first frame member laterally slidable against a second frame member, the first frame member including a catch operative to engage at least one of a plurality of notches within the second frame member so that changing the widthwise dimension includes repositioning the biased dowel into another of the plurality of openings.

6. The pressure gate of claim 4, wherein the repositionable frame members include a first frame member laterally slidable against a second frame member, the first frame member including a plurality of notches operative to engage a catch of the second frame member so that changing the widthwise dimension includes repositioning the biased dowel into another of the plurality of openings.

7. The pressure gate of claim 4, wherein the repositionable frame members include a first frame member telescopically repositionable with respect to a second frame member, the first frame member including dowel adapted to be received into at least one of a plurality of holes through the second frame member to inhibit the first frame member from telescopically repositioning with respect to the second frame member.

8. The pressure gate of claim 4, wherein the repositionable frame members include a first frame member telescopically repositionable with respect to a second frame member, the first frame member including a plurality of holes therethrough, where at least one of the plurality of holes is adapted to receive a dowel of the second frame member to inhibit the first frame member from telescopically repositioning with respect to the second frame member.

9. The pressure gate of claim 4, further comprising:
a latch receiver mounted to at least one of the frame assembly and the door;
a handle assembly mounted to at least one of the frame assembly and the door opposite the latch receiver, the handle assembly including a latch mechanism operative to engage the latch receiver to selectively inhibit the door from pivoting about the frame assembly opposite the handle assembly.

10. The pressure gate of claim 9, wherein:
the handle assembly includes a safety to maintain the interface between the latch and the latch receiver;
an actuator is operatively coupled to the latch and operative to reposition the latch and selectively interface the latch receiver; and
the safety is adapted to engage the actuator in a safe position to inhibit movement of the actuator to reposition the latch.

11. The pressure gate of claim 10, wherein:
the safety is biased in the safe position;
the latch includes a projection; and
the latch receiver includes a cavity adapted to receive the projection.

12. The pressure gate of claim 11, wherein:
the latch is biased against the actuator;
the actuator is biased with respect to the handle assembly;
the latch is repositionable with respect to the handle assembly without requiring repositioning of the actuator.

13. The pressure gate of claim 12, wherein:
a first spring interposes the latch and actuator;
a second spring interposes the actuator and the handle assembly;
the latch slides on a track of the handle assembly; and
the latch includes an opening through which a segment of the actuator pierces.

14. The pressure gate of claim 9, wherein:
the latch includes a projection;
the latch receiver includes a cavity adapted to receive the projection; and
the handle assembly includes an actuator operatively coupled to the latch, where movement of the actuator is operative to reposition the latch with respect to the latch receiver.

15. The pressure gate of claim 14, wherein:
the latch is biased against the actuator;
the actuator is biased against the handle assembly;
the latch is repositionable with respect to the handle assembly without requiring repositioning of the actuator.

16. The pressure gate of claim 15, wherein:
a first spring interposes the latch and actuator;
a second spring interposes the actuator and the handle assembly;
the latch slides on a track of the handle assembly; and
the latch includes an opening through which a segment of the actuator pierces.

17. The pressure gate of claim 4, wherein:
the door is pivotally mounted to the frame assembly via a hinge that includes cooperating members to facilitate pivotal movement between the door and frame assembly;
the door includes a first cooperating member;
the frame member includes a second cooperating member.

18. The pressure gate of claim 17, wherein:
the frame assembly includes two hinges;
the second cooperating member includes an appendage that is engaged by the first cooperating member; and
the appendage of the first hinge is oriented opposite the appendage of the second hinge.

19. The pressure gate of claim 18, wherein:
the second cooperating member includes a bracket from which the appendage extends; and
the first cooperating member includes a ring that circumferentially pivots about the appendage.

20. The pressure gate of claim 18, wherein:
the appendage includes a cylindrical knob; and
the first cooperating member includes an eyebolt incorporating the ring to circumferentially pivots about the cylindrical knob.

21. The pressure gate of claim 17, wherein at least one of the first cooperating member and the second cooperating member is repositionable with respect to at least one of the frame member and the door to adjust a distance between the door and the frame member.

22. The pressure gate of claim 4, wherein:
the door is pivotally mounted to the frame assembly via a hinge that includes cooperating members to facilitate pivotal movement between the door and frame assembly;
the frame member includes a first cooperating member;
the door includes a second cooperating member.

23. The pressure gate of claim 22, wherein:
the frame assembly includes two hinges;
the second cooperating member includes an appendage that is engaged by the first cooperating member; and
the appendage of the first hinge is oriented opposite the appendage of the second hinge.

24. The pressure gate of claim 23, wherein:
the second cooperating member includes a bracket from which the appendage extends; and
the first cooperating member includes a ring that circumferentially pivots about the appendage.

25. The pressure gate of claim 23, wherein:
the appendage includes a cylindrical knob; and
the first cooperating member includes an eyebolt incorporating the ring to circumferentially pivots about the cylindrical knob.

26. The pressure gate of claim 22, wherein at least one of the first cooperating member and the second cooperating member is repositionable with respect to at least one of the frame member and the door to adjust a distance between the door and the frame member.

27. The pressure gate of claim 4, wherein the door includes a first section repositionable with respect to a second section to increase a widthwise dimension of the door.

28. The pressure gate of claim 4, wherein:
the first section includes a track mounted thereto, the track including a plurality of spaced depressions, where at least one of the plurality of spaced depressions is operative to receive a projection.
the second section rides upon the track and includes an actuator operative to reposition the projection with respect to the plurality of spaced depressions; repositioning the projection from a first depression to a second depression is operative to change the widthwise dimension of the door.
